(19) United States
(12) Patent Application Publication
(10) Pub. No.: US 2008/0204412 A1
(43) Pub. Date: Aug. 28, 2008

(54) USER INTERFACE NAVIGATION MECHANISM AND METHOD OF USING THE SAME

(76) Inventors: Peter ON, San Diego, CA (US); Eduardo Ahumada Apodaca, La Jolla, CA (US); John David Salisbury, Carlsbad, CA (US)

Correspondence Address: KYOCERA WIRELESS CORP., P.O. BOX 928289, SAN DIEGO, CA, 92192-8289, US

(21) Appl. No.: 11/677,984

(22) Filed: Feb. 22, 2007

(51) Int. Cl. G06F 3/033

(52) U.S. Cl. 345/160

(57) ABSTRACT

A user interface navigation mechanism for a non-touch screen display of a computing device includes a vertical tracking input disposed in a front of the computing device in a right margin between a right of the non-touch screen display and a right of the computing device, the vertical tracking input including an up input, a down input, and a vertical selection point; and a horizontal tracking input disposed in the front of the computing device in a bottom margin between a bottom of the non-touch screen display and a bottom of the computing device, the horizontal tracking input including a left input, a right input, and a horizontal selection point; and a main menu input disposed in the front of the computing device.

### FIELD OF THE INVENTION

The present invention generally relates to user interface navigation for computing devices and particularly to user interface navigation for wireless communication devices.

### BACKGROUND

Touch-screen interfaces are known for computing devices. With a touch-screen interface, a user contacts the screen with one's finger or a stylus to navigate displayed menus and provide input into the computing device. Problems with touch-screen interfaces include that the touch screen can become damaged, scratched, and/or soiled because contact with the screen is required to provide input into the computing device. Also, touch-screen technology is relatively expensive, increasing the cost of the personal computing device.

### SUMMARY

Accordingly, an aspect of the invention involves a user interface navigation mechanism that overcomes the problems with touch-screen interfaces and is intuitive, easy to use, unique, functional, and enhances the user experience.

Another aspect of the invention involves a user interface navigation mechanism for a non-touch screen display of a computing device. The computing device includes a top, a bottom, a left side, a right side, a front, a rear, the non-touch screen display disposed in the front of the computing device and including a top, a bottom, a left side, a right side, and the front of the computing device including a top margin between the top of the non-touch screen display and the top of the computing device, a bottom margin between the bottom of the non-touch screen display and the bottom of the computing device, a left margin between the left of the non-touch screen display and the left of the computing device, and a right margin between the right of the non-touch screen display and the right of the computing device. The user interface navigation mechanism includes a vertical tracking input disposed in the front of the computing device in the right margin between the right of the non-touch screen display and the right of the computing device, the vertical tracking input including an up input, a down input, and a vertical selection point; a horizontal tracking input disposed in the front of the computing device in the bottom margin between the bottom of the non-touch screen display and the bottom of the computing device, the horizontal tracking input including a left input, a right input, and a horizontal selection point; and a main menu input disposed in the front of the computing device.

A further aspect of the invention involves a method of processing user input on a user interface navigation mechanism for a non-touch screen display of a computing device. The computing device includes a top, a bottom, a left side, a right side, a front, a rear, the non-touch screen display disposed in the front of the computing device and including a top, a bottom, a left side, a right side, and the front of the computing device including a top margin between the top of the non-touch screen display and the top of the computing device, a bottom margin between the bottom of the non-touch screen display and the bottom of the computing device, a left margin between the left of the non-touch screen display and the left of the computing device, and a right margin between the right of the non-touch screen display and the right of the computing device, a vertical tracking input disposed in the front of the computing device in the right margin between the right of the non-touch screen display and the right of the computing device, the vertical tracking input including an up input, a down input, and a vertical selection point, a horizontal tracking input disposed in the front of the computing device in the bottom margin between the bottom of the non-touch screen display and the bottom of the computing device, the horizontal tracking input including a left input, a right input, and a horizontal selection point, and a main menu input disposed in the front of the computing device. The method includes presenting on the non-touch screen display a main menu based upon user contact with the main menu input; moving or navigating vertically through vertical menu items based upon user contact with the up input and down input of the vertical tracking input to highlight a vertical menu item; selecting the highlighted vertical menu item based upon user contact with the vertical selection input; moving or navigating horizontally through horizontal menu items based upon user contact with the left input and right input of the horizontal tracking input to highlight a horizontal menu item; and selecting the highlighted horizontal menu item based upon user contact with the horizontal selection input.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts.

FIG. 1 is a simplified front elevational view of an embodiment of a user interface navigation mechanism.

FIG. 2 is a flow chart of an exemplary method of processing user input on a user interface navigation mechanism.

FIG. 3 is a block diagram illustrating an example wireless communication device that may be used in connection with various embodiments described herein.

FIG. 4 is a block diagram illustrating an example computer system that may be used in connection with various embodiments described herein.

### DETAILED DESCRIPTION

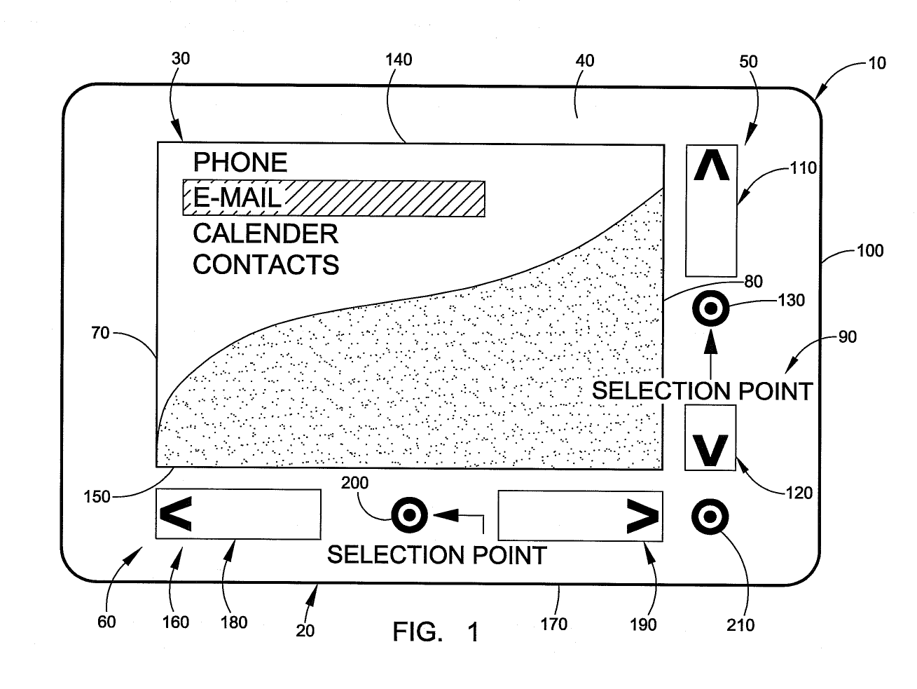

With reference to FIG. 1, an embodiment of a user interface navigation mechanism and method of use for a wireless communication device will be described. Although the user interface navigation mechanism will be described in conjunction with a wireless communication device, in alternative embodiments, the user interface navigation mechanism is used with other computing devices including a display.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

With reference to FIG. 1, an embodiment of a user interface navigation mechanism 10 for a computing device such as a wireless communication device 20 will be described. The wireless communication device 20 includes a display/monitor/screen (“display”) 30, which is not a touch screen. Accordingly, input can not be input into wireless communication device 20 via touching or contacting display 30.

Although not shown, wireless communication device 20 includes an antenna and appropriate electronic circuitry and/or software for controlling the wireless functions and other functions described herein.

Wireless communication device 20 includes front 40 with user interface navigation mechanism 10 therein. User interface navigation mechanism 10 includes vertical tracking input 50 and horizontal tracking input 60.

Vertical tracking input 50 is disposed adjacent to left side edge 70 or right side edge 80 of display 30, along substantially the entire side edge 70, 80. In the embodiment shown, vertical tracking input 50 is disposed adjacent to right side edge 80 of display 30, in the right margin 90 between right side edge 80 of display 30 and right edge 100 of wireless communication device 20. Vertical tracking input 50 includes up input 110, down input 120, and vertical selection point 130, which enables user input, at a midpoint between up input 110 and down input 120. Inputs 110, 120, 130 of vertical tracking input 50 are one or more of resistive touch sensors, capacitive touch sensors, and inductive touch sensors. In an alternative embodiment, vertical tracking input 50 includes one or more mechanical buttons. In an embodiment of vertical tracking input 50, wireless communication device 20 includes a circuit board with one or more illumination devices (e.g., LED(s)) and respective light pipe(s) for illuminating or backlighting vertical tracking input 50. The illumination of vertical tracking input 50 in this manner visually distinguishes vertical tracking input 50 from display 30.

Horizontal tracking input 60 is disposed adjacent to top edge 140 or bottom edge 150 of display 30, along substantially entire top/bottom edge 140, 150. In the embodiment shown, horizontal tracking input 60 is disposed adjacent to bottom edge 150 of display 30, in bottom margin 160 between bottom edge 140 of display 30 and bottom edge 170 of wireless communication device 20. Horizontal tracking input 60 includes left input 180, right input 190, and horizontal selection point 200, which enables user input, at a midpoint between left input 180 and right input 190. Inputs 180, 190, 200 of horizontal tracking input 60 are one or more of resistive touch sensors, capacitive touch sensors, and inductive touch sensors. In an alternative embodiment, horizontal tracking input 60 includes one or more mechanical buttons. In an embodiment of horizontal tracking input 60, wireless communication device 20 includes a circuit board with one or more illumination devices (e.g., LED(s)) and respective light pipe(s) for illuminating or backlighting horizontal tracking input 60. The illumination of horizontal tracking input 60 in this manner visually distinguishes horizontal tracking input 60 from display 30.

Wireless communication device 20 includes front 40 with dedicated main menu button 210 located in a corner at an intersection of vertical tracking input 50 and horizontal tracking input 60. Dedicated main menu button 210 can function as an escape button to a main menu when selected.

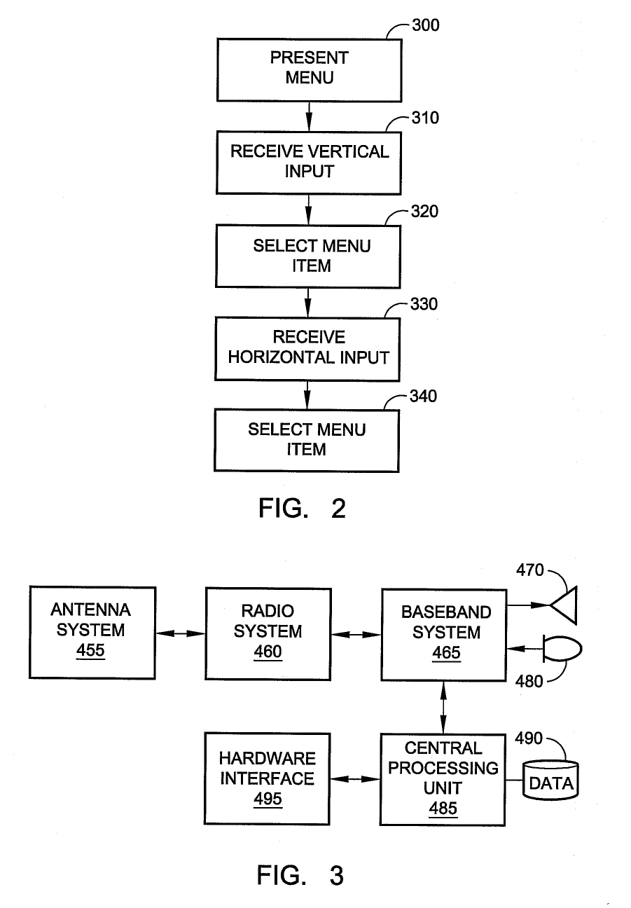

With reference to FIG. 2, user interface navigation mechanism 10 will now be described in use. To bring up a main menu on display 30, a user presses dedicated main menu button 210. At step 300, a main menu is displayed or presented in display 30. A user moves/scrolls/navigates vertically through vertically aligned items in main menu (and/or sub-menus) by pressing/touching up input 110 and down input 120 of vertical tracking input 50, highlighting one of the vertical menu items. A user presses vertical selection point 130 to select a vertical menu item. Accordingly, at step 310, vertical input is received by the interface navigation mechanism 10 of the wireless communication device 20, and, at step 320, a menu item is selected. A user moves/scrolls/navigates horizontally through horizontally aligned items (or to bring up a horizontally disposed sub-menu) by pressing/touching right input 190 (and/or left input 180) of horizontal tracking input 60, highlighting one of the horizontal menu items (or activating a horizontally disposed sub-menu). A user presses horizontal selection point 200 to select a horizontal menu item (or activate a horizontally disposed sub-menu). Accordingly, at step 330, horizontal input is received by the interface navigation mechanism 10 of the wireless communication device 20, and, at step 340, a menu item is selected.

In a similar manner, a cursor or other object can be moved around display 30 using vertical tracking input 50 and horizontal tracking input 60.

Thus, user interface navigation mechanism 10 overcomes the problems with touch-screen interfaces. User interface navigation mechanism 10 helps prevent display 30 from becoming damaged, scratched, and/or soiled because contact with the screen is not required to provide input into the computing device. Also, user interface navigation mechanism 10 is less expensive than touch-screen technology, reducing the cost of the personal computing device. Further, user interface navigation mechanism 10 is intuitive being situated adjacent to the display, easy to use, unique, functional, and enhances the user experience.

FIG. 3 is a block diagram illustrating an example wireless communication device 450 that may be used in connection with various embodiments described herein. For example, the wireless communication device 450 may be a wireless communication device having the aforementioned user interface navigation mechanism 10. However, other wireless communication devices and/or architectures may also be used, as will be clear to those skilled in the art.

In the illustrated embodiment, wireless communication device 450 comprises an antenna system 455, a radio system 460, a baseband system 465, a speaker 464, a microphone 470, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) to perform the functions described above with respect to FIG. 2.

In this description, the term “computer readable medium” is used to refer to any media used to provide executable instructions (e.g., software and computer programs) to the wireless communication device 450 for execution by the central processing unit 485. Examples of these media include the data storage area 490, microphone 470 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

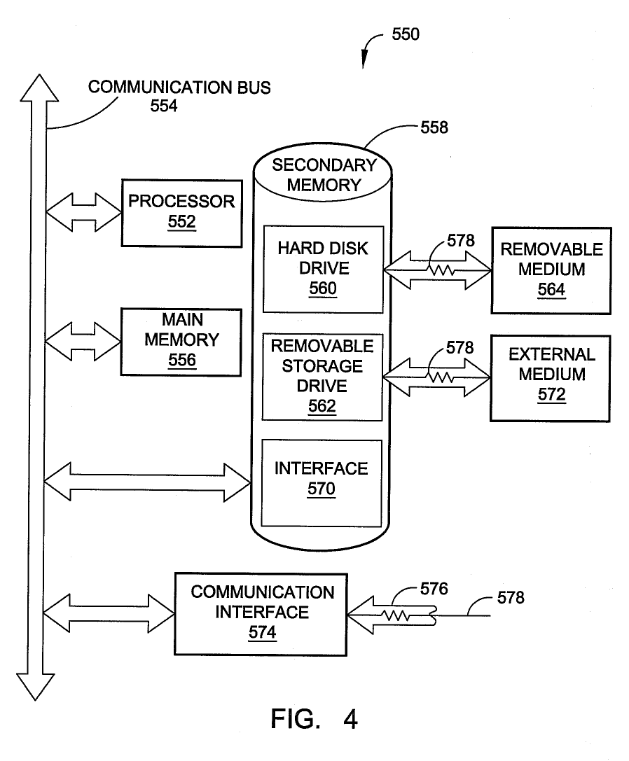

FIG. 4 is a block diagram illustrating an example computer system 550 that may be used in connection with various embodiments described herein. For example, the computer system 550 may be used in conjunction with a computer having the aforementioned user interface navigation mechanism 10. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A user interface navigation mechanism for a non-touch screen display of a computing device, the computing device including a top, a bottom, a left side, a right side, a front, a rear, the non-touch screen display disposed in the front of the computing device and including a top, a bottom, a left side, a right side, and the front of the computing device including a top margin between the top of the non-touch screen display and the top of the computing device, a bottom margin between the bottom of the non-touch screen display and the bottom of the computing device, a left margin between the left of the non-touch screen display and the left of the computing device, and a right margin between the right of the non-touch screen display and the right of the computing device, the user interface navigation mechanism comprising:
a vertical tracking input disposed in the right margin, the vertical tracking input including an up input, a down input, and a vertical selection point;
a horizontal tracking input disposed in the bottom margin, the horizontal tracking input including a left input, a right input, and a horizontal selection point; and
a main menu input disposed in the front of the computing device.

2. The user interface navigation mechanism of claim 1, wherein vertical tracking input includes at least one of resistive touch sensors, capacitive touch sensors, and inductive touch sensors.

3. The user interface navigation mechanism of claim 1, wherein vertical tracking input includes at least one of mechanical buttons and keys.

4. The user interface navigation mechanism of claim 1, wherein horizontal tracking input includes at least one of resistive touch sensors, capacitive touch sensors, and inductive touch sensors.

5. The user interface navigation mechanism of claim 1, wherein horizontal tracking input includes at least one of mechanical buttons and keys.

6. The user interface navigation mechanism of claim 1, further including at least one illumination device and light pipe to illuminate the vertical tracking input and horizontal tracking input.

7. A method of processing user input on a user interface navigation mechanism for a non-touch screen display of a computing device, the computing device including a top, a bottom, a left side, a right side, a front, a rear, the non-touch screen display disposed in the front of the computing device and including a top, a bottom, a left side, a right side, and the front of the computing device including a top margin between the top of the non-touch screen display and the top of the computing device, a bottom margin between the bottom of the non-touch screen display and the bottom of the computing device, a left margin between the left of the non-touch screen display and the left of the computing device, and a right margin between the right of the non-touch screen display and the right of the computing device, a vertical tracking input disposed in the right margin, the vertical tracking input including an up input, a down input, and a vertical selection point, a horizontal tracking input disposed in the bottom margin, the horizontal tracking input including a left input, a right input, and a horizontal selection point, and a main menu input disposed in the front of the computing device, the method comprising:
presenting on the non-touch screen display a main menu based upon user contact with the main menu input;
navigating vertically through vertical menu items in response to user contact with the up input and down input of the vertical tracking input to highlight a vertical menu item;
selecting the highlighted vertical menu item based upon user contact with the vertical selection input;
navigating horizontally through horizontal menu items in response to user contact with the left input and right input of the horizontal tracking input to highlight a horizontal menu item;
selecting the highlighted horizontal menu item based upon user contact with the horizontal selection input.

8. The method of claim 7, further comprising receiving vertical tracking input from at least one of resistive touch sensors, capacitive touch sensors, and inductive touch sensors.

9. The method of claim 7, further comprising receiving vertical tracking input from at least one of mechanical buttons and keys.

10. The method of claim 7, further comprising receiving horizontal tracking input from least one of resistive touch sensors, capacitive touch sensors, and inductive touch sensors.

11. The method of claim 7, further comprising receiving horizontal tracking input from least one of mechanical buttons and keys.

12. The method of claim 7, further comprising illuminating the vertical tracking input and horizontal tracking input with least one illumination device and light pipe.
